(19) United States
(12) Patent Application Publication
(10) Pub. No.: US 2023/0164259 A1
(43) Pub. Date: May 25, 2023

(54) REMOVABLE HAND SANITIZER ACCESSORY

(71) Applicant: Gregory Alexander Castrodale, Richfield, OH (US)

(72) Inventor: Gregory Alexander Castrodale, Richfield, OH (US)

(21) Appl. No.: 18/052,699

(22) Filed: Nov. 4, 2022

Related U.S. Application Data
(60) Provisional application No. 63/263,524, filed on Nov. 4, 2021.
(60) Provisional application No. 63/263,526, filed on Nov. 4, 2021.
(60) Provisional application No. 63/363,512, filed on Apr. 25, 2022.

(51) Int. Cl. H04M 1/17; H04M 1/02

(52) U.S. Cl. CPC H04M 1/17; H04M 1/026

(57) ABSTRACT

A magnetic mobile phone accessory including a card holder with an integrated sanitizer dispenser.

### CROSS-REFERENCE

This application claims the benefit of U.S. Provisional Application No. 63/263,524, filed Nov. 4, 2021, U.S. Provisional Application No. 63/263,526, filed Nov. 4, 2021 U.S. Provisional Application No. 63/363,512, filed Apr. 25, 2022, all of these applications incorporated herein by reference in its entirety.

### FIELD OF THE INVENTION

This invention relates to an accessory of a portable device containing dispensable hand sanitizer.

### BACKGROUND OF THE INVENTION

The Centers for Disease Control and Prevention do note that, when it comes to preventing the spread of coronavirus, “if soap and water are not readily available, use a hand sanitizer that contains at least 60% alcohol.” Indeed, that is the primary ingredient in hand sanitizer: alcohol. Most hand sanitizers contain anywhere from 60% to 95% isopropyl or ethyl alcohol mixed with water and gels like glycol and glycerin in order to prevent drying out users' skin.

### SUMMARY OF THE INVENTION

While alcohol has been in use as an antiseptic since the late-1800s, a hand sanitizer is only useful if actually applied frequently. The hand sanitizer described herein makes hand sanitizer instantly available for a user any time place the users handheld and thus will encourage more frequent hand sanitizer use. In some aspects hand sanitizer can be supplied in a watch band, or an accessory to be secured to a case for a portable electronic device.

Other methods, features and/or advantages is, or will become, apparent upon examination of the following Figures and detailed description. It is intended that all such additional methods, features, and advantages be included within this description and be protected by the accompanying claims.

### BRIEF DESCRIPTION OF THE DRAWINGS

The novel features of the invention are set forth with particularity in the claims. A better understanding of the features and advantages of the present invention will be obtained by reference to the following detailed description that sets forth illustrative embodiments, in which the principles of the invention are used, and the accompanying drawings of which:

FIG. 1 depicts a side elevation view of an accessory attached to a mobile device.

FIG. 2 depicts a side elevation exploded view of an accessory.

FIG. 3 depicts a bottom elevation view of an accessory attached to a mobile device.

FIG. 4 depicts a bottom elevation view of an accessory attached to a mobile device.

FIG. 5 depicts a side exploded view of an accessory attached to a mobile device.

FIG. 6 depicts a side exploded view of an accessory attached to a mobile device.

FIG. 7 depicts a side exploded view of an accessory attached to a mobile device.

FIG. 8A-8C depicts top, bottom and side views of an accessory according to the present invention.

FIG. 9A-9D depicts top, bottom and side exploded views of an accessory according to the present invention.

FIG. 10A-10D depicts top, bottom and side exploded views of an accessory according to the present invention.

FIG. 11A-11E depicts top bottom and side elevation views of attachment of an accessory to a mobile device with a magnet.

FIG. 12 depicts a side elevation view of an accessory according to the present invention.

FIG. 13A-13D depicts a side elevation view of an accessory according to the present invention.

### DETAILED DESCRIPTION OF THE INVENTION

### Definitions

As used in the specification and the claims, the singular forms “a,” “an,” and “the” include plural referents unless the context clearly dictates otherwise.

### Overview of Invention Aspects

In additional aspects of the invention, the invention includes a card holder with an integrated sanitizer dispenser, or a sanitizer dispenser with an integrated card holder.

In additional aspects of the invention the lever also referred to as the slide and an indent for hand grip/stand as well as a simple pressure point for squeezing.

In additional aspects of the invention, a magnetic attachment compatible and slides on and off.

In additional aspects of the invention, it may incorporate a magnetic attachment with an include back piece or may use a protruding clip for holding cards down.

In additional aspects, the invention may include an indent for a finger grip and/or stand or may include an attachment that attaches with the ability for the unit to disconnect with a push of a button.

In additional aspects, the invention may include a slide for opening and closing with a spring and O-ring.

In additional aspects the invention includes an integrated sanitizer dispenser that is independent unit that is removable from the card holder. The card holder may contains holes that mate with prongs of a hand sanitizer containing pod so that the pod may be removed and replaced as necessary.

### Disclosed Embodiments are Non-Limiting

While various embodiments of the present invention have been shown and described herein, it is emphasized that such embodiments are provided by way of example only. Numerous variations, changes and substitutions may be made without departing from the invention herein in its various embodiments. Specifically, and for whatever reason, the shape, size or material of the device may be altered and not depart from the spirit of the invention.

Moreover, when any range is described herein, unless clearly stated otherwise, that range includes all values therein and all sub-ranges therein.

### Examples

The examples herein provide some examples, not meant to be limiting.

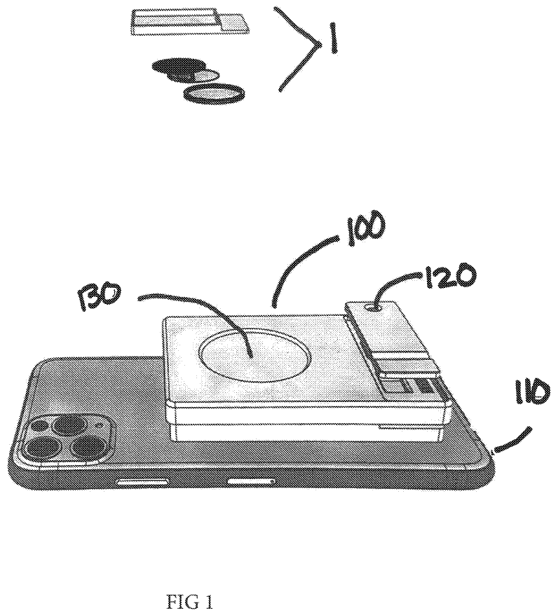

Referring now to FIG. 1, an aspect of the invention will now be discussed. An accessory 100 may be secured to a mobile device such as a cellular phone 110. The accessory contains an outlet port 120 for dispensing a liquid or gel such as a hand sanitizer. The accessory Additionally, the accessory may include means 130 for attachment of an additional devices to the accessory, such as a pop-socket.

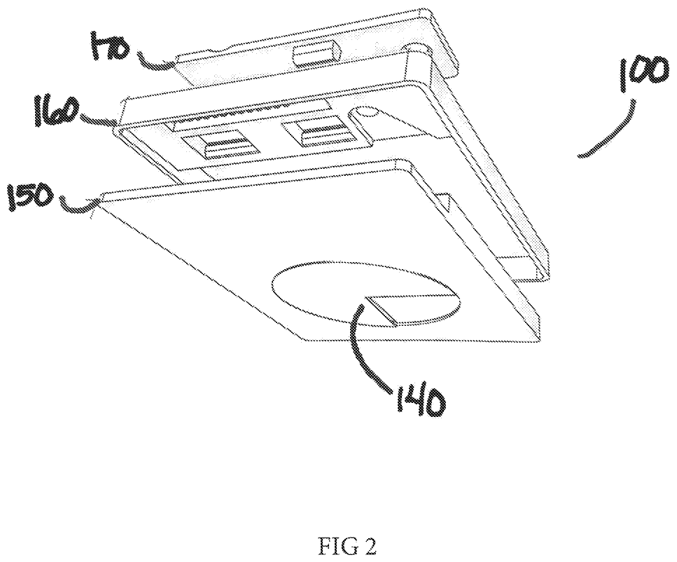

Referring to FIG. 2, an exploded bottom view of the accessory 100. The accessory includes a means 140 for attachment of the accessory to a mobile device (not shown). It is noted the accessory may generally contain four parts, a bottom plate 150, a top plate 160, another plate on the inside and a lever 170. Depending on model used determines the amount of pieces.

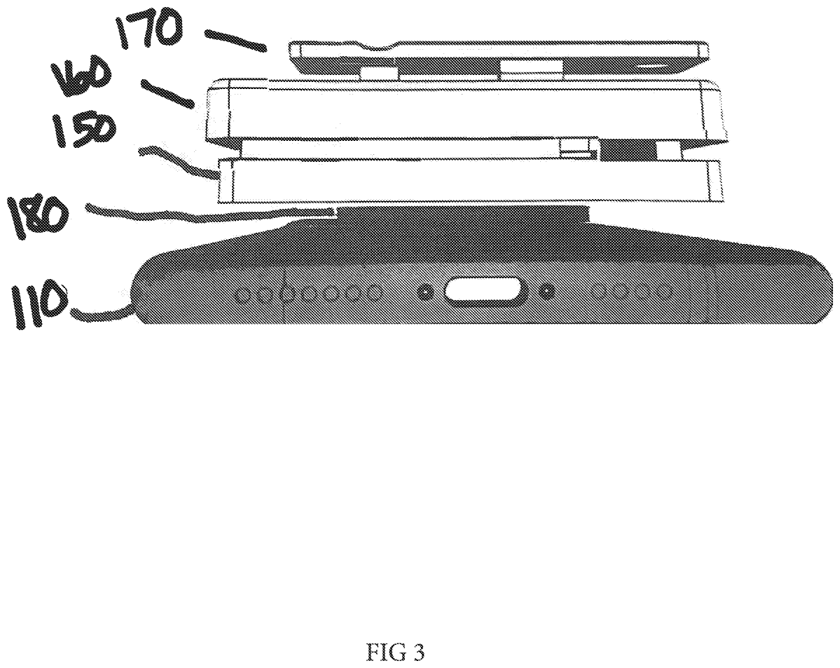

Referring now to FIG. 3, an additional aspect of the invention is disclosed. In this case, viewing the accessory 100 and the mobile device 110 from the bottom, a securing means 180 is viewed. The securing means 180 is compatible with the accessory means 140 for attachments of the accessory to the mobile device. The bottom plate 150, top plate 160 and lever 170 of the accessory are also visible in this view.

Referring now to FIG. 4, an additional aspect of the invention is disclosed. In this case, a view of a fully assembled accessory 190 secured to a mobile device 110 is shown. A top plate, 200, a lever 210 and, outlet port 220 for dispensing a liquid or gel such as a hand sanitizer are found.

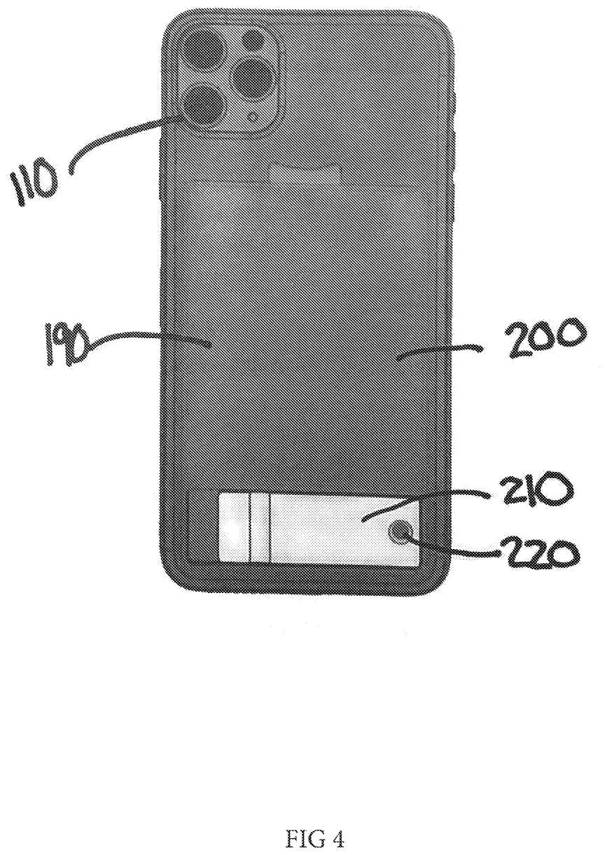

Referring now to FIG. 5, an exploded view of an aspect of the invention is shown.

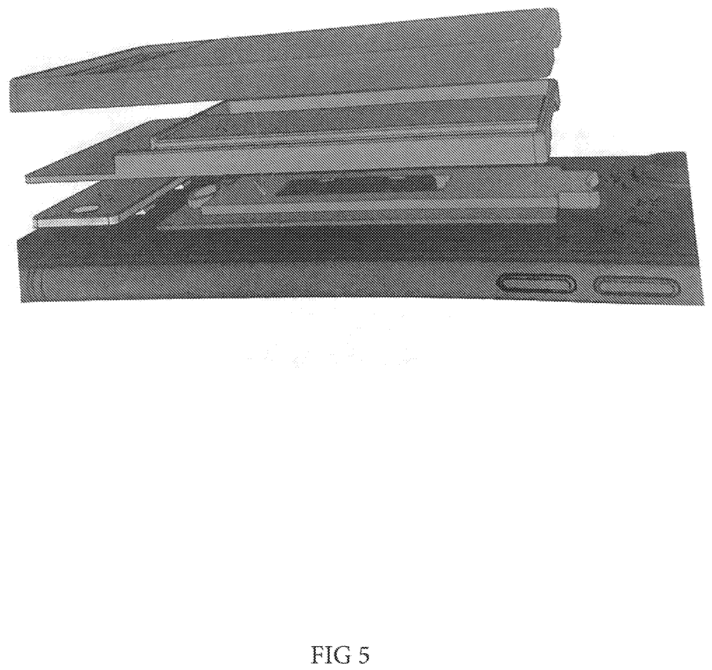

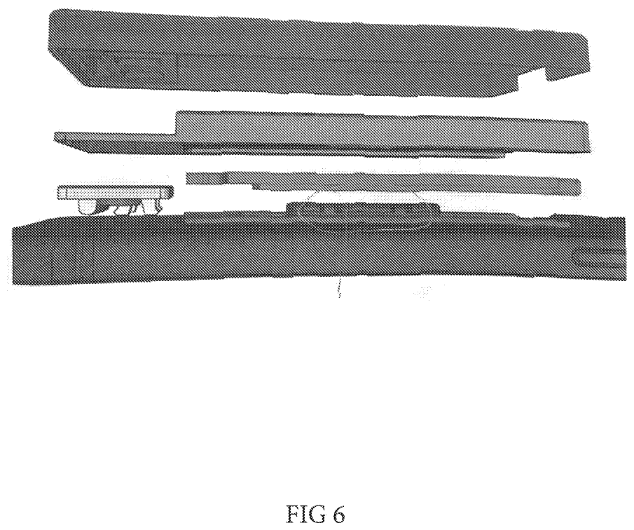

Referring now to FIG. 6, an additional exploded view of an aspect of the invention is shown.

Referring now to FIG. 7, a top elevation and exploded view of an aspect of the invention is shown.

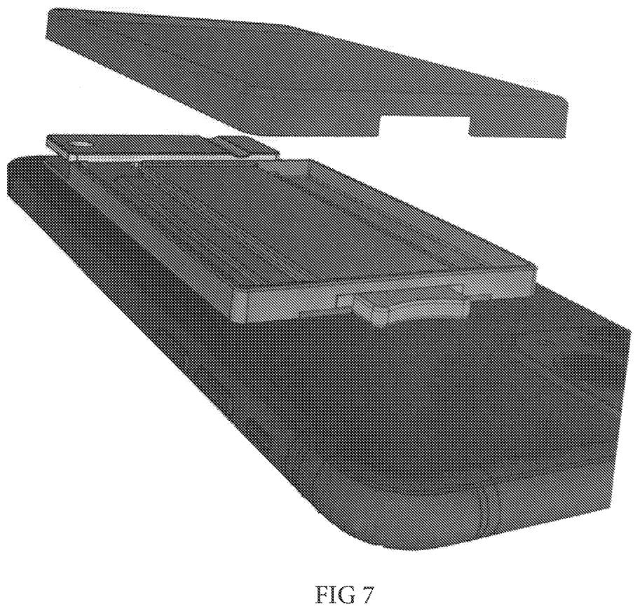

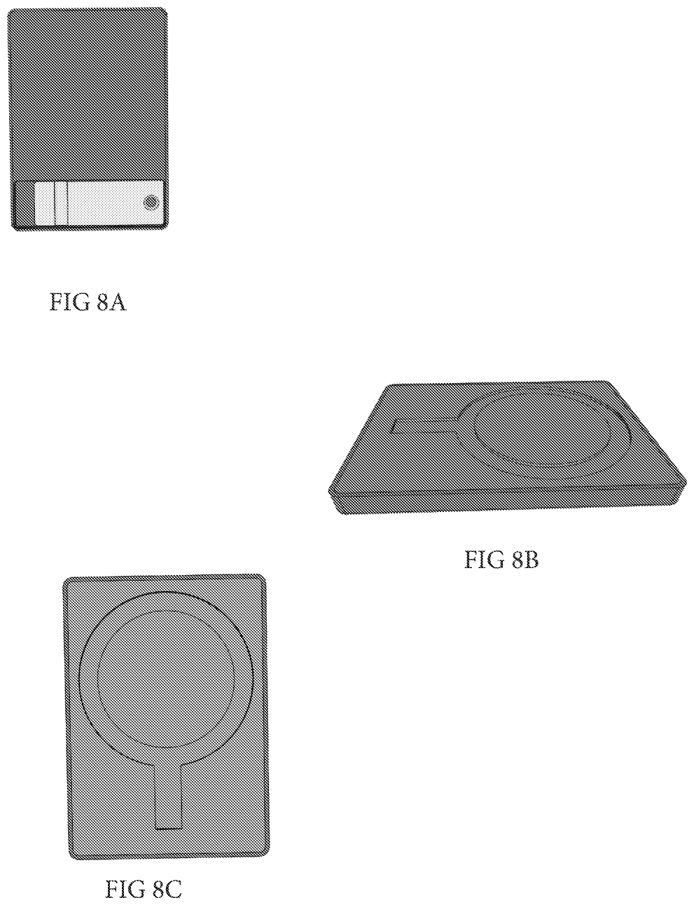

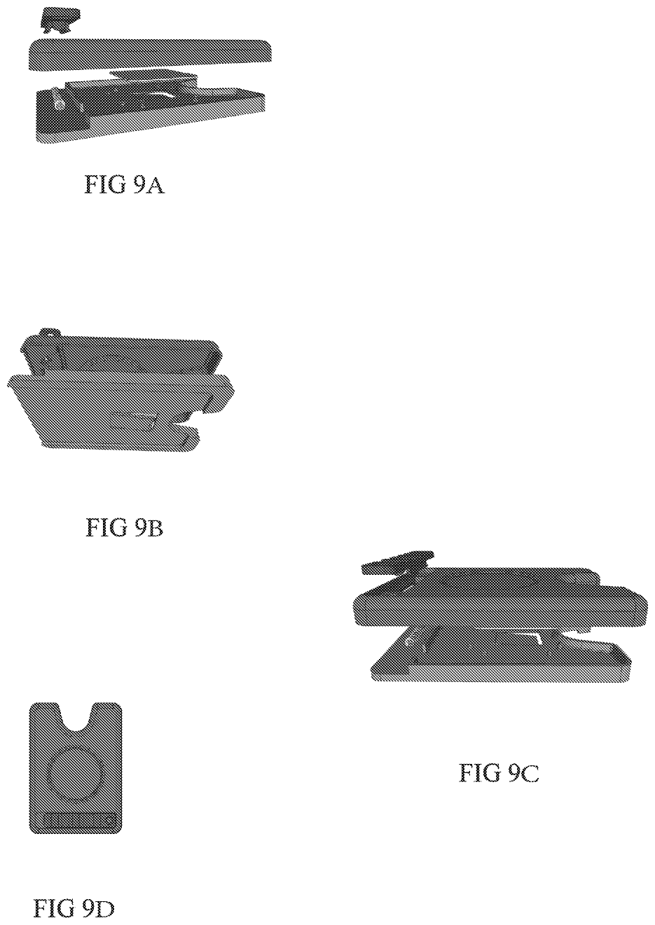

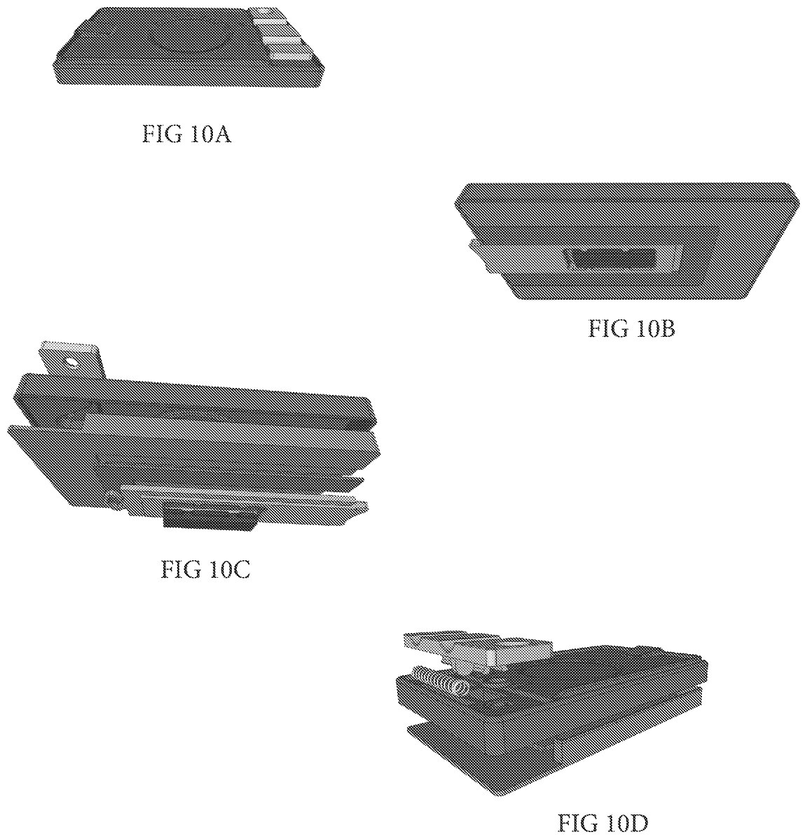

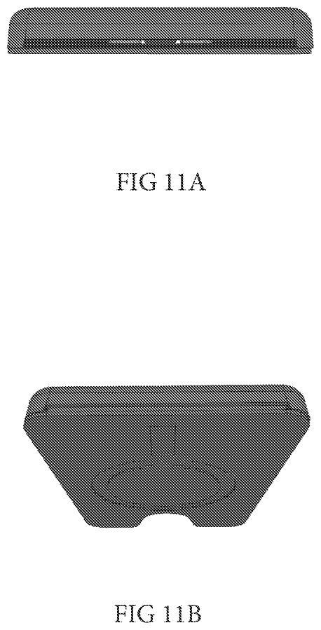

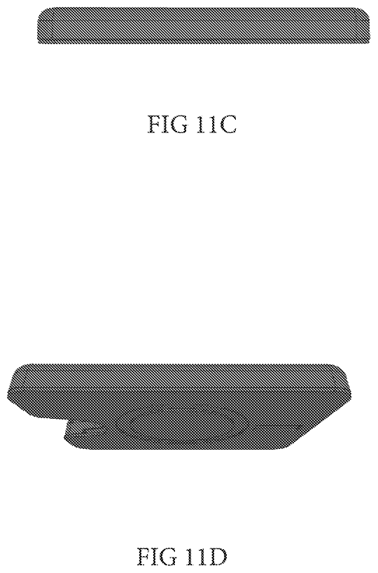

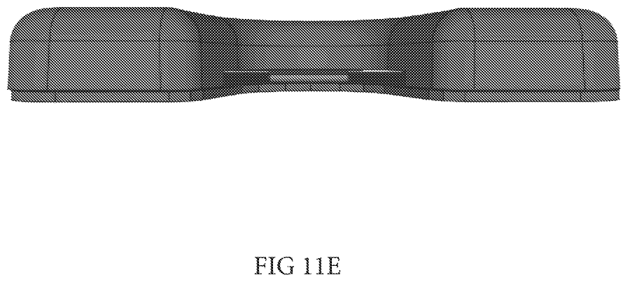

Referring now to FIGS. 8-11, views of the accessory are shown in the absence of a cellular device.

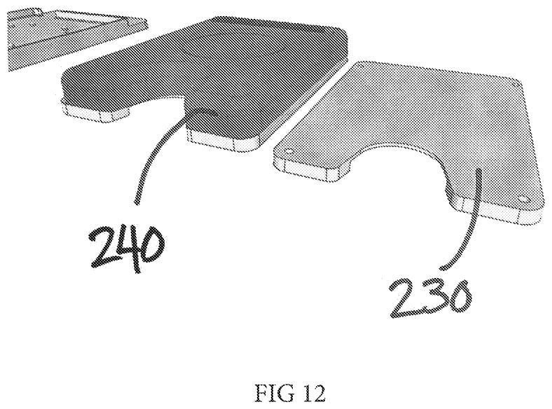

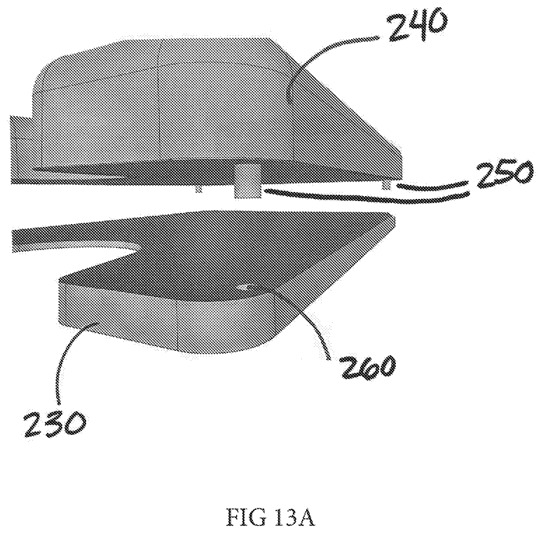

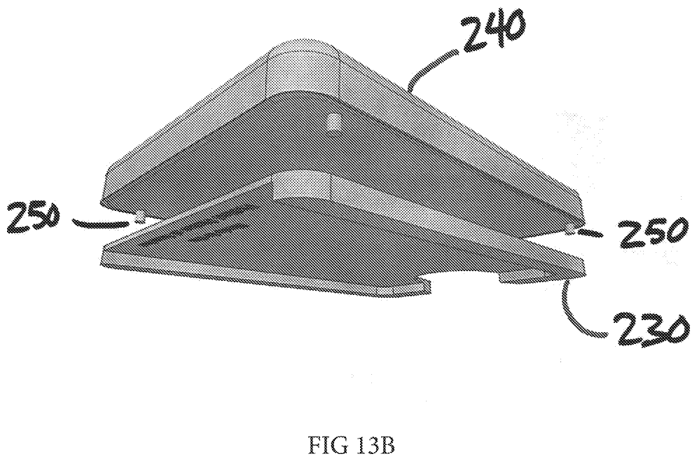

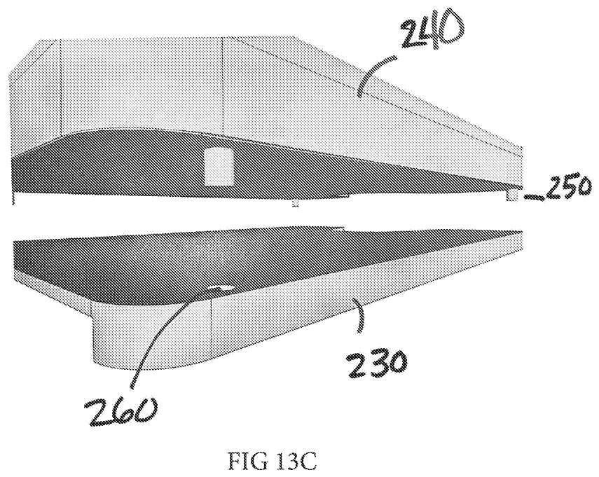

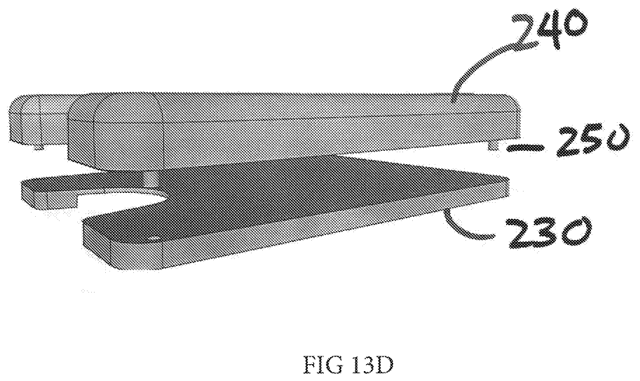

Referring now of FIG. 12, the accessory may include a card holder 230 that is adjacent to a cell phone or other device and a removable hand sanitizer pod 240 that is secured to the card holder 230. FIG. 13 described the interrelationship between the pod and the card holder in greater detail. In FIG. 13A-13D a card holder 230 is secured to a cell phone or other device (not shown) and a pod/container that may contain hand sanitizer 240 is secured to the card holder 230 when prongs 250 located on the pod 240 snap into holes 260 located on the card holder 230. Of course, any means of attachment of the pod to the card holder are encompassed by the invention. The number of holes 260 on the card holder and the number of prongs 250 on the pod may be varied according to the needs of the user. Preferably there are a complimentary set of four prongs and hold disposed near each corner of the device but other configurations are possible. The pod may contain writing or logo.

1. A solution dispenser comprising:
a. magnetic means for attachment to a mobile device;
b. a bottom plate;
c. a top plate compatible with the bottom plate;
d. an enclosed pod containing a solution; and
e. a lever with an outlet port for dispensing a solution that is a liquid or gel from the enclosed pod.

2. The solution dispenser of claim 1, further comprising:
means for dispensing the solution from the enclosed pod only when intended; and
prongs for securing the pod to a card holder.

3. A combination of a solution dispenser and a card holder that comprises means for attachment to a cellular phone.
